(19) United States
(12) Patent Application Publication
(10) Pub. No.: US 2009/0151862 A1
(43) Pub. Date: Jun. 18, 2009

(54) METHOD AND APPARATUS FOR CONTINUOUSLY STRETCHING POLYMER FILMS

(75) Inventors: Shinsuke Aoshima, Minami-ashigara-shi (JP); Misao Takahashi, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/334,327

(22) Filed: Dec. 12, 2008

(30) Foreign Application Priority Data
Dec. 14, 2007 (JP) 2007-322904

(51) Int. Cl. B32B 37/04; B32B 37/00

(52) U.S. Cl. 156/157; 156/391

(57) ABSTRACT

A rear end of a preceding film and a front end of a trailing film are overlapped with an overlap length Lo. Each of a pair of welding heads has a contact surface and a film heating surface. The contact surface has a length Lp in a conveying direction. The film heating surface has a length Lh in the conveying direction. The lengths Lh, Lo, and Lp satisfy Lh<Lo<Lp. Center portions of an overlapped portion, the contact surface, and the heat surface are approximately aligned with each other in the conveying direction. The overlapped portion is sandwiched by the welding heads in an overlapping direction C. The overlapped portion is welded through the film heating surfaces such that temperatures of the films at both ends of each contact surface in the conveying direction are heated to a temperature at which the films are welded.

### FIELD OF THE INVENTION

The present invention relates to a method and an apparatus for continuously stretching spliced polymer films.

### BACKGROUND OF THE INVENTION

A polymer film (hereinafter referred to as film) has advantages such as excellent light transmission properties and flexibility, and is easy to be made lighter and thinner. Accordingly, the film is widely used as an optical functional film. TAC film formed of cellulose acylate, in particular, cellulose triacetate (TAC) with an average acetylation degree in a range from 57.5 to 62.5% has toughness and flame retardancy, and therefore the TAC film is utilized as a film base for photosensitive material. Additionally, since the TAC film has optical isotropy superior to other polymer films, the TAC film is utilized as an optical film such as a protective film for a polarizing filter, an optical compensation film, for example, a wideview film, in an LCD and the like.

As a film production method, mainly, there are a melt-extrusion method and a solution casting method. In the melt-extrusion method, a polymer is heated to be melted, and then extruded by an extruder to form a film. The melt-extrusion method has advantages such as high productivity and relatively low equipment cost. However, it is difficult to adjust thickness accuracy of the film, and fine streaks (die lines) appear on the film. Accordingly, the melt-extrusion method is not suitable for the production of the optical film. In the solution casting method, on the other hand, a polymer solution (hereinafter referred to as a dope) containing a polymer and a solvent is cast onto a support to form a casting film. After the casting film obtains the self-supporting property, the casting film is peeled from the support as a wet film. The wet film is dried while being conveyed to be a film. To remove wrinkles and slacks formed on the film during the production process or to impart desired optical properties to the film, a clip tenter or the like is used to stretch the film in the width direction while the film is conveyed at a predetermined conveying speed. Lastly, the film is wound in a roll using a winding device or the like. Thus, long films are successively and efficiently produced by the solution casting method in which film production processes are performed continuously. The films produced by the solution casting method has superior optical anisotropy and thickness evenness and a smaller amount of foreign substances compared to those produced by the melt-extrusion method. Therefore, the solution casting method is adopted to produce optical films, in particular, TAC film.

There is an increase in demand for the optical films such as the TAC film associated with rapid development and widespread use of the LCD and the like. An increase in productivity of the optical films is demanded.

To perform high-speed film production by the solution casting method, it is necessary that the casting film obtains self-supporting property in a short time while the moving speed of the support is increased. To impart the self-supporting property to the casting film, a method such as a drying method in which a solvent contained in the casting film is evaporated or a cooling gelation method in which the casting film is cooled may be used.

To perform the high-speed film production by the solution casting method using the drying method, high-speed drying of the casting film is necessary. However, such high-speed drying causes unevenness in drying which results in surface defects on the film. On the other hand, the high-speed film production by the solution casting method using the cooling gelation method does not cause the above described defects. Therefore, in view of increasing the production efficiency, the cooling gelation method is more likely to be adopted for imparting the self-supporting property to the casting film.

The support moving speed and the film conveying speed of the clip tenter differ in their optimum values. Although the cooling gelation method is adopted to increase the production efficiency, substantial increase cannot be achieved since the film conveying speed in the clip tenter is slower than the support moving speed. To solve this problem, it is suggested to separate the film production line and the film stretching line (hereinafter referred to as off-line stretching apparatus), and use the film production line and the off-line stretching apparatus in combination (for example, see Japanese Patent Laid-Open Publication No. 2002-311240). In the film production line, a casting film is formed and dried to be a film, and the produced film is wound in a film roll. In the off-line stretching apparatus, the film fed from the film roll is stretched.

To stretch the film efficiently in the off-line stretching apparatus, as disclosed in Japanese Patent Laid-Open Publication No. 2002-311240, it is preferable to continuously stretch the films fed from the film rolls. After the used film roll is replaced with a new film roll, a rear end of a preceding film and a front end of a trailing film are overlapped, and then heated while being pressed. Thus, the overlapped portion is spliced (hereinafter referred to as welding process). For example, the welding process disclosed in Japanese Utility Model Laid-Open Publication No. 53-020268 is known. By splicing the two films, the films are supplied to the off-line stretching apparatus without interruption. As a result, the film stretching process is efficiently performed in the off-line stretching apparatus.

In the case where the overlapped portion and its vicinity are subjected to the welding process to ensure splicing of the front end and the rear end of two films, a certain amount of difference in thickness (hereinafter referred to as thickness unevenness) develops in the vicinity of the overlapped portion between a melted portion of the film and an unmelted portion of the film. When such film is stretched, the film may be ruptured from a portion having the thickness unevenness. On the other hand, in a case where a length of a welding area on the overlapped portion is made shorter than the length of the overlapped portion in the film conveying direction, both film edges of the overlapped portion in the film conveying direction are not welded. Such film ends are snagged on a part or a member in the off-line stretching apparatus. As a result, convey failure and/or film rupture may occur.

### SUMMARY OF THE INVENTION

In view of the above, an object of the present invention is to provide a method and an apparatus for continuously stretching polymer films, in which two polymer films are overlapped and spliced by sufficiently applying a welding process to the overlapped portion.

To achieve the object and other objects, a method for continuously stretching polymer films according to the present invention includes the following steps: overlapping a rear end of a preceding polymer film and a front end of a trailing polymer film as an overlapped portion; splicing the overlapped portion by holding and welding the overlapped portion between a pair of welding heads in an overlapping direction, and each welding head has a film contact surface to contact with the overlapped portion and a film heating surface to heat the overlapped portion; and stretching the spliced polymer film in a width direction in a state that side edges of the spliced polymer film in the width direction are held. A length Lo of the overlapped portion in a conveying direction of the polymer films, a length Lp of the film contact surface in the conveying direction, and the length Lh of the film heating surface in the conveying direction satisfy Lh<Lo<Lp. Center portions of the overlapped portion, the film contact surface, and the film heating surface are approximately aligned with each other in the conveying direction. Ends of the overlapped portion in the conveying direction are heated during the welding to a temperature at which the polymer films are welded to each other.

It is preferred that each of the welding heads is provided with a separating layer, and the separating layer covers the film contact surface and the film heating surface, and the overlapped portion is welded through the separating layers. It is preferred that the length Lo is at least 5 mm and at most 10 mm, and a difference (Lp−Lo) is at most 10 mm.

An apparatus for continuously stretching polymer films in a film width direction according to the present invention includes a pair of welding heads, a film conveying device, and a heating control device. The welding heads holds, welds, and splices an overlapped portion of the polymer films in an overlapping direction. Each welding head has a film contact surface to contact with the overlapped portion and a film heating surface to heat the overlapped portion. A length Lp of the film contact surface in a conveying direction of the polymer films and a length Lh of the film heating surface in the conveying direction satisfy Lh<Lp. The film heating surface is approximately flush with the film contact surface and extends from a center portion toward ends of the film contact surface in the conveying direction at approximately equal lengths. Center portions of the film contact surface and the film heating surface are approximately aligned to each other in the conveying direction. The film conveying device overlaps a rear end of a preceding polymer film and a front end of a trailing polymer film as the overlapped portion in such a manner that center portions of the overlapped portion and the film heating surface are approximately aligned with each other in the conveying direction and a length Lo of the overlapped portion in the conveying direction satisfies Lh<Lo<Lp. The heating control device controls the temperature of the film heating surface such that ends of the overlapped portion in the conveying direction are heated during said welding to a temperature at which the polymer films are welded to each other.

It is preferred that each of the welding heads is provided with a separating layer, and the separating layer covers the film contact surface and the film heating surface.

In the present invention, the welding process is adequately performed to the overlapped portion where a front end and a rear end of two films are overlapped. By splicing the two films into one film, stretching process is continuously applied under the identical conditions to the spliced film while the conveyance failure and rupture of the spliced film are prevented. Therefore, according to the present invention, the stretching process is efficiently preformed in the off-line stretching apparatus. Thus, a film having excellent surface conditions and uniform optical properties without slacks and wrinkles is efficiently produced.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is a schematic lateral view of an off-line stretching device;

FIG. 2 is a plan view of a tenter section;

FIG. 3 is a front view of a clip;

FIG. 4 is a perspective view of an essential portion of a splicing unit;

FIG. 5 is a section view of the essential portion of the splicing unit;

FIG. 6 is an explanatory view showing steps of welding process using welding heads;

FIG. 7 is an explanatory view of a temperature profile of a splicing section in the welding process;

FIG. 8 is a section view of an essential portion of the splicing unit having a separating layer;

FIG. 9 is an explanatory view of a solution casting apparatus;

FIG. 10 is an explanatory view of the solution casting apparatus;

FIG. 11 is a perspective view showing an arrangement of rollers in a heat treatment zone; and

FIG. 12 is an explanatory view showing a lap length (D) and a roller interval length (G) in the heat treatment zone.

### DESCRIPTION OF THE PREFERRED EMBODIMENTS

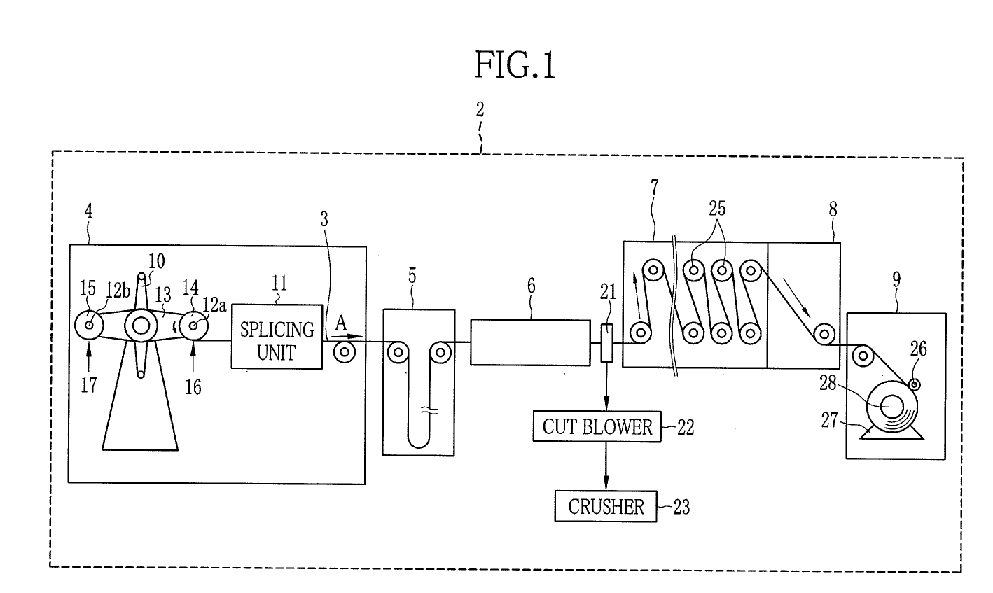

As shown in FIG. 1, an off-line stretching device 2 is provided with a film supply chamber 4 for supplying a film 3, a reservoir 5, a tenter section 6, a heat relaxation chamber 7, a cooling chamber 8, and a winding chamber 9 in this order. In the tenter section 6, the film 3 is stretched continuously without interruption.

The film supply chamber 4 is provided with a turret-type film feeding device 10 and a splicing unit 11. The film feeding device 10 has a turret arm 13. The ends of the turret arm 13 are provided with mounting shafts 12a and 12b respectively. The mounting shaft 12a is loaded with a film roll 14. The turret arm 13 is rotated by 180° (degrees) at a time to set the mounting shaft 12a in a film feeding position 16, which sets the other mounting shaft 12b in a film replacement position 17. Thus, the film roll 14 is set in the film feeding position 16.

The film feeding device 10 feeds the film 3 from the film roll 14 to the splicing unit 11. A core of the used-up film roll is taken off from the mounting shaft 12b in the film replacement position 17, and a new film roll 15 is loaded. When the film feeding device 10 detects that the film 3 of the film roll 14 in the film feeding position 16 is used up, the turret arm 13 is rotated by 180° (degrees) so that the mounting shaft 12b loaded with the new film roll 15 is moved from the film replacement position 17 to the film feeding position 16. Thereby, the film 3 is fed from the new film roll 15. The film rolls 14 and 15 are the rolls of films produced by a solution casting method of a drying method or a gel-cooling method.

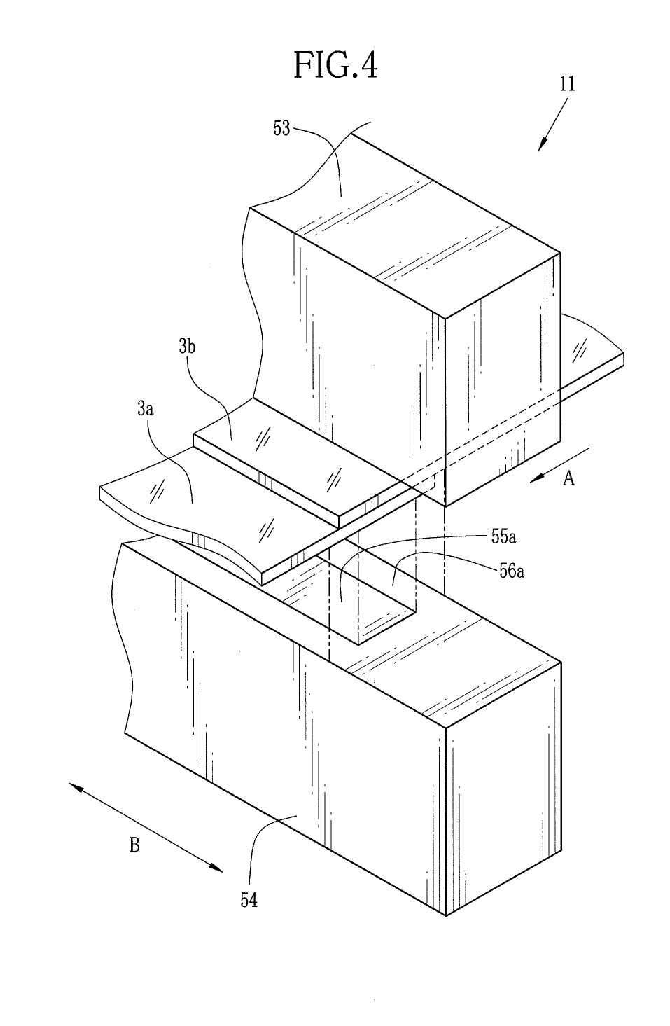

In the splicing unit 11, a rear end of the film (preceding film) 3a (see FIG. 4) fed the film roll 14 and a front end of the film (trailing film) 3b (see FIG. 4) fed from the film roll 15 are spliced together by a welding process, and the spliced film is referred to as the film 3. The film 3 is conveyed to the reservoir 5. The splicing unit 11 and the welding process will be detailed later. The reservoir 5 is provided with a loop longer than a length necessary to keep the preceding film 3a inside the reservoir 5 during the welding process. After the films 3a and 3b are spliced together as the film 3, the film 3 is conveyed to the tenter section 6. The loop is formed by making a moving speed Va of the preceding film upstream from the reservoir 5 faster than a moving speed Vb of the preceding film downstream from the reservoir 5. The length of the loop is made longer than the product of the time needed for welding and the moving speed in the tenter section 6.

In the tenter section 6, side edges of the film 3 are held and stretched in the film width direction under a predetermined condition, and then the film 3 is sent to an edge slitting device 21. The edge slitting device 21 cuts off the side edges of the film 3. Thereafter, the film 3 as a product is sent to the heat relaxation chamber 7. The cut side edges are sent to a cut blower 22, and further cut into small pieces. The small pieces of the cut side edges are sent to a crusher 23 using a pneumatic-conveying device (not shown), and pulverized to chips. The chips are reused for the dope preparation.

The heat relaxation chamber 7 is provided with a plurality of rollers 25 and a duct (not shown) used for drying the film 3. The film 3 is conveyed by the rollers 25 through the heat relaxation chamber 7 and relaxed by heat. Thereafter, the film 3 is sent to the cooling chamber 8. A temperature of air from the duct is preferably in a range from 20° C. to 250° C.

After the heat relaxation, the film 3 is cooled in the cooling chamber 8 to 30° C. or less, and then sent to the winding chamber 9. The winding chamber 9 is provided with a winding device 27 having a press roller 26. The winding device 27 winds the film 3 around a core 28. At the time of winding, the press roller 26 presses the film 3 in a direction toward the core 28.

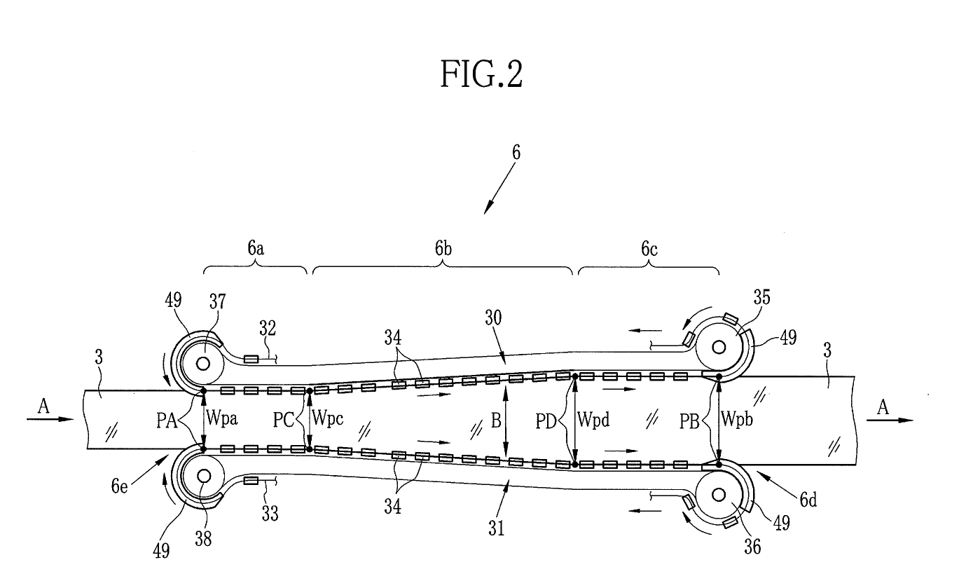

As shown in FIG. 2, the tenter section 6 stretches the film 3 in a film width direction B while conveying the film 3 in a film conveying direction A. The tenter section 6 is provided with a first rail 30, a second rail 31, and a first chain (endless chain) 32 guided by the first rail 30, and a second chain (endless chain) 33 guided by the second rail 31. The tenter section 6 is disposed in a drying chamber (not shown). The drying chamber is provided with a preheating zone 6a, a heating zone 6b, and a heat relaxation zone 6c in this order in the film conveying direction A. Dry air is supplied to each of the preheating zone 6a, the heating zone 6b, and the heat relaxation zone 6c through ducts (not shown) to achieve optimum film temperature in each zone. The stretching ratio in the tenter section 6 is changed as necessary in accordance with desired optical properties or the like. It is preferable to stretch the film 3 in the film width direction in a range from 100.5% to 300%.

The first chain 32 and the second chain 33 are provided with a plurality of clips 34 at predetermined intervals. The clips 34 start holding the film 3 at a point (hereinafter referred to as film holding position) PA, and release the film 3 at a point (hereinafter referred to as film releasing position) PB. The clips 34 start stretching the film 3 at a point PC, and stop stretching the film 3 at a point PD. A film width Wpa at the film holding position PA and a film width Wpc at the point PC are approximately the same. A film width Wpb at the film releasing position PB and a film width Wpd at the point PD are approximately the same. The film width Wpd is larger than the film width Wpc. In other words, in the preheating zone 6a, the film 3 is preheated while its film width is kept unchanged. In the heating zone 6b, the film width is gradually increased by stretching during the conveyance. In the heat relaxation zone 6c, the film 3 is heated and relaxed while the film width is kept unchanged.

The first chain 32 is bridged across a driving sprocket 35 and a driven sprocket 37. The second chain 33 is bridged across a driving sprocket 36 and the driven sprocket 38. The driving sprockets 35 and 36 are provided on a tenter outlet 6d side. The driving sprockets 35 and 36 are driven and rotated by a driving mechanism (not shown). The driven sprockets 37 and 38 are provided on a tenter inlet 6e side. The first chain 32 moves around the driving sprocket 35 and the driven sprocket 37 while being guided by the first rail 30. The second chain 33 moves around the driving sprocket 36 and the driven sprocket 38 while being guided by the second rail 31.

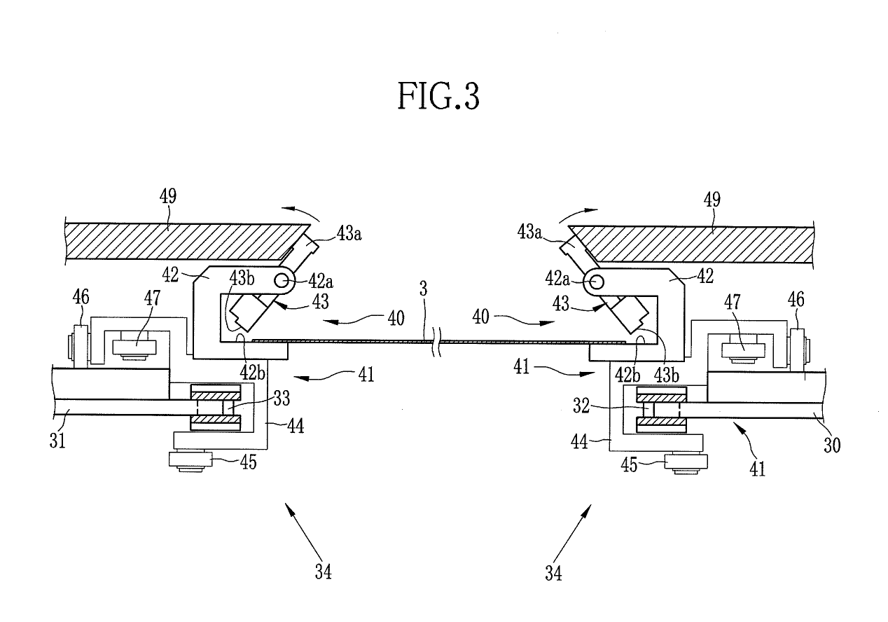

As shown in FIG. 3, the clip 34 is constituted of a clip body 40 and a rail attachment portion 41. The clip body 40 is constituted of a frame 42 having an approximately U-shaped cross section and a flapper 43. The flapper 43 is attached to the frame 42 in a rotatable manner through a shaft 42a. The flapper 43 shifts between a holding position (closed position) and a release position. In the closed position, the flapper 43 stands approximately vertical. In the release position, a releasing member 49 contacts with an engaging head 43a such that the flapper 43 is held in a slanting position to release the film 3. The flapper 43 is biased by a spring (not shown) or its own weight to be kept in the closed position unless the releasing member 49 comes in contact with the engaging head 43a. When the flapper 43 is in the closed position, the film 3 is held between a film holding surface 42b and a flapper lower surface 43b.

The rail attachment portion 41 is constituted of an attachment frame 44, guide rollers 45, 46, and 47. The attachment frame 44 is attached to the first chain 32 or the second chain 33. The guide rollers 45, 46, and 47 are rotated while contacting with the supporting surfaces of the driving sprocket 35, the driven sprocket 37 or the first rail 30, or, the supporting surfaces of the driving sprocket 36, the driven sprocket 38 or the second rail 31 (see FIG. 2). Thereby, the clip body 40 is guided along the first rail 30 or the second rail 31 without falling off from the driving sprocket 35, the driven sprocket 37 or the first rail 30, or, the driving sprocket 36, the driven sprocket 38 or the second rail 31.

The releasing member 49 of the clip 34 is disposed in the vicinity of each of the sprockets 35 to 38 (see FIG. 2). The engaging head 43a of the clip 34 that reached close to the driven sprocket 37 or 38 at the tenter inlet 6e (see FIG. 2) comes in contact with the releasing member 49. Thereby, the flapper 43 of the clip 34 is positioned in the release position and becomes ready to hold the side edge of the film 3 before the clip 34 reaches the film holding position PA (see FIG. 2). Then, the engaging head 43a comes off the releasing member 49 when the clip passes the film holding position PA so that the flapper 43 of the clip 34 is set in the closed position to hold the side edge of the film 3. Likewise, the engaging head 43a of the clip 34 reaching close to the driving sprocket 35 or 36 comes in contact with the releasing member 49. Thereby, the flapper 43 of the clip 34 is positioned in the release position at the film releasing position PB, and thus the side edge of the film 3 is released.

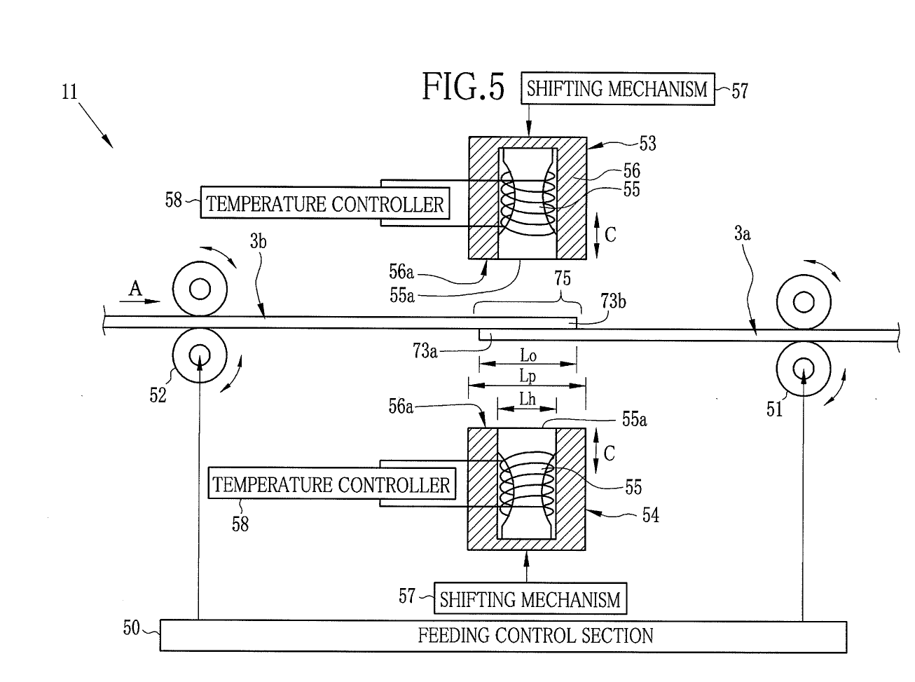

As shown in FIGS. 4 and 5, a splicing unit 11 has a feeding control section 50, nip roller pairs 51 and 52, an upper welding head 53, and a lower welding head 54. Under the control of the feeding control section 50, the preceding film 3a or the trailing film 3b is held between and conveyed by the nip roller pair 51 or 52 in the film conveying direction A to perform an overlapping process. Hereinafter this positional adjustment of the rear end 73a of the preceding film 3a and the front end 73b of the trailing film 3b by the nip roller pairs 51 and 52 to precisely overlap the films 3a and 3b for splicing is referred to as the overlapping process.

Each of the welding heads 53 and 54 is constituted of a heater 55 and a metal main body 56 surrounding the heater 55. The main body 56 has a contact surface 56a. The welding heads 53 and 54 are disposed such that the contact surfaces 56a are opposed through the films 3a and 3b. A film heating surface 55a of the heater 55 is exposed at and flush with the contact surface 56a. The film heating surface 55a extends from a center portion toward ends of the film contact surface 56a in the film conveying direction A at approximately equal lengths. The width of the film heating surface 55a in the film width direction B is approximately equal to or larger than the width of the film 3a or 3b.

The heater 55 is an electrothermal heater. The heater 55 is heated to a predetermined temperature by applying predetermined driving pulses thereto. During the welding process, the heater 55 is set at a temperature that heats the overlapped portions 75 of the films 3a and 3b contacting the contact surface 56a to a welding temperature. The welding temperature is a temperature at which the films 3a and 3b are welded to each other. When the application of the driving pulses is stopped, the main body 56 acts as a radiator so that the heater 55 and the main body 56 are cooled down to predetermined temperatures or lower. Then, the main body 56 is set to a retracted position. Thus, the overlapped portion 75 is welded by the heater 55, and then cooled. After being cooled, the overlapped portion 75 obtains a predetermined welding strength such that the films 3a and 3b do not separate from each other at the overlapped portion 75. It is preferred that the heater 55 and the main body 56 are formed of a material with excellent thermal conductivity, for example, aluminum, aluminum alloy, or the like.

A shifting mechanism 57 and a temperature controller 58 are connected to each of the welding heads 53 and 54. The shifting mechanism 57 moves the welding heads 53 and 54 between a welding position and the retracted position. When the welding heads 53 and 54 are in the welding position, the film heating surface 55a of the upper welding head 53 comes in contact with the trailing film 3b, and the film heating surface 55a of the lower welding head 54 comes in contact with the preceding film 3a. When the welding heads 53 and 54 are in the retracted position, the welding heads 53 and 54 are retracted from the films 3b and 3a respectively. The temperature controller 58 applies predetermined pulses to heat the heater 55 to a predetermined temperature.

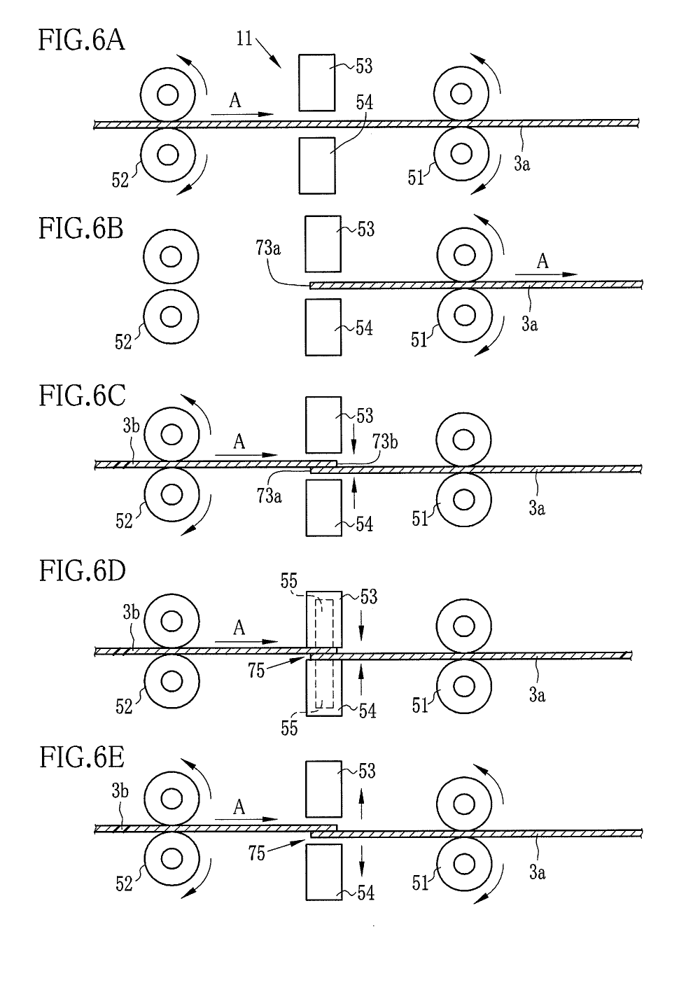

Next, the welding process performed in the splicing unit 11 is described. As shown in FIG. 1 and FIG. 6A, the film feeding device 10 feeds the preceding film 3a from the film roll 14 to the splicing unit 11. Under the control of the feeding control section 50, the nip roller pairs 51 and 52 convey the preceding film 3a to the reservoir 5. Thereafter, when the feeding control section 50 detects that the preceding film 3a of the film roll 14 is used up, the film feeding device 10 rotates the turret arm 13 by 180° (degrees), which moves the new film roll 15 from the film replacement position 17 to the film feeding position 16. Thereby, the trailing film 3b is fed from the new film roll 15.

Under the control of the feeding control section 50, the nip roller pair 51 controls the conveyance of the preceding film 3a to put a rear end 73a in the welding position (see FIG. 6B), and the nip roller pair 52 controls the conveyance of the trailing film 3b to put a front end 73b in the welding position (see FIG. 5 and FIG. 6C). Thus, the rear end 73a and the front end 73b are overlapped one another in the welding position in the splicing unit 11. The overlapped portions of the rear end 73a and the front end 73b are referred to as overlapped portion 75.

In FIG. 5, the nip roller pairs 51 and 52 perform the overlapping process of the films 3a and 3b, in other words, adjust the positions of the rear end 73a and the front end 73b to overlap the films 3a and 3b, so as to satisfy Lh<Lo<Lp where Lh is a length of the film heating surface 55a in the film conveying direction A, Lp is a length of the contact surface 56a in the film conveying direction A, and Lois a length of the overlapped portion 75 in the film conveying direction A, and to approximately align center portions of the overlapped portion 75, the contact surface 56a, and the film heating surface 55a with each other in the film conveying direction A.

The shifting mechanism 57 moves the upper welding head 53 and the lower welding head 54 to the welding position to sandwich the overlapped portion 75 with the contact surfaces 56a at predetermined pressure in an overlapping direction C (see FIG. 5 and FIG. 6D). Thereafter, the temperature controller 58 heats the heater 55 so as to heat the ends of the films 3a and 3b of the overlapped portion 75 in the film conveying direction A to a predetermined temperature. The films 3a and 3b are held between and heated through the contact surfaces 56a for a predetermined time. Thus, the films 3a and 3b are welded. Thereafter, the temperature controller 58 turns off the heater 55 so that the heat of the heater 55 and the main body 56 is dissipated for a predetermined time while the films 3a and 3b are held between the upper and the lower welding heads 53 and 54. Thus, the rear end 73a of the preceding film 3a and the front end 73b of the trailing film 3b are spliced. The heating time with the use of the film heating surfaces 55a and the heat-dissipation time may be determined as necessary with reference to the production conditions.

Lastly, the shifting mechanism 57 moves the upper welding head 53 and the lower welding head 54 from the welding position to the retracted position. Then, the nip roller pairs 51 and 52 send the welded films 3a and 3b as the film 3 to the tenter section 6 through the reservoir 5 (see FIG. 6E).

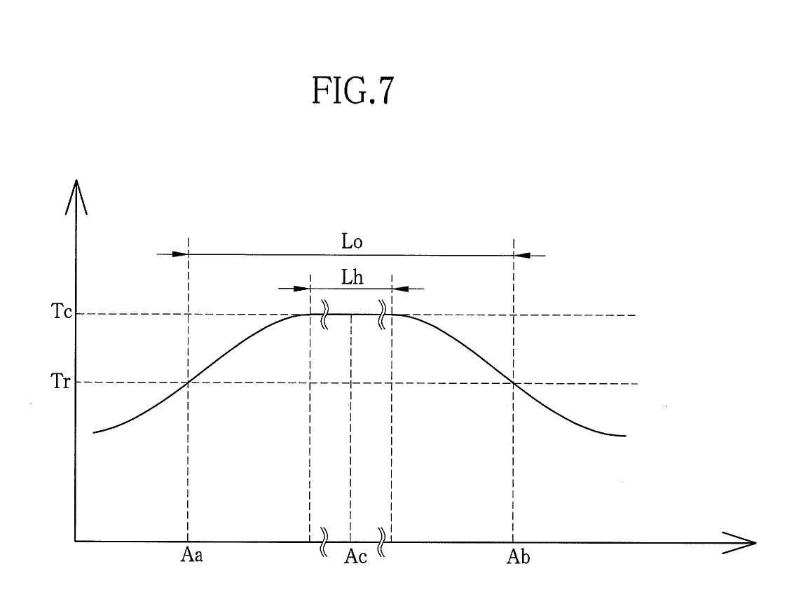

In FIG. 7, the vertical axis indicates the temperature of the overlapped portion 75. “Tc” is the temperature of the film heating surface 55a, and “Tr” is a welding temperature of the films 3a and 3b. The horizontal axis indicates a position in the overlapped portion 75 in the film conveying direction A. “Aa” is the position of the rear end 73a. “Ab” is the position of the front end 73b. “Ac” is the center portion of the overlapped portion 75 in the film conveying direction A. The temperature Tc of the film heating surface 55a is controlled by the temperature controller 58 to be kept at a desired value. The length Lo is adjusted to a desired value by the overlapping process. By adjusting the length Lh of the film heating surface 55a, the length Lo, and the temperature Tc, the temperatures of the rear end 73a and the front end 73b are adjusted to the welding temperature Tr. Thus, the films 3a and 3b within the overlapped portion 75 are welded. The temperatures of the rear end 73a and the front end 73b may be set higher than the welding temperature Tc under controlled conditions in which the welding of the films 3a and 3b outside the overlapped portion 75 is avoided.

In the present invention, the entire overlapped portion 75 is pressed, and the approximate center portion of the overlapped portion 75 in the film conveying direction A is heated. Accordingly, the films 3a and 3b are heated, melted, and spliced in the overlapped portion 75 while the films 3a and 3b outside the overlapped portion 75 are prevented from melting, which prevents thickness unevenness of the spliced film 3. Since the rear end 73a of the preceding film 3a and the front end 73b of the trailing film 3b do not extend off the overlapped portion 75, snagging of the rear end 73a and the front end 73b on the clips 34 of the tenter section 6 or the like, which frequently occurred in the conventional method, is prevented. As a result, rupture of the spliced film 3 is prevented. Thus, the present invention precisely applies the welding process to the overlapped portion 75, which prevents the thickness unevenness, conveyance failures, and the rupture of the film caused by inadequate splicing of the front end 73b and the rear end 73a.

The temperature of the film heating surface 55a is set in a range from, for example, at least 150° C. to at most 400° C. at which polymer contained in each film 3a and 3b is melted but not decomposed. Pressure applied by the contact surfaces 56a to the overlapped portion 75 is preferred to be at least 0.1 MPa. To prevent foam in the films 3a and 3b, and to ensure the welding process, the pressure applied to the overlapped portion 75 is preferred to be at least 1 MPa.

The length Lo, Lh, and Lp in the above embodiment are determined as necessary with respect to the given conditions. For example, the length Lo of the overlapped portion 75 in the film conveying direction A is preferred to be at least 5 mm so as to ensure adequate splicing strength. An upper limit to the length Lo is not particularly limited, but preferred to be at most 10 mm. A difference (Lo−Lh) is preferred to be at most 8 mm. A difference (Lp−Lo) may be determined based on variations in the positions of the rear end 73a and the front end 73b of the overlapped portion 75, for example, at most 10 mm. The upper limit of the difference (Lp−Lo) is preferred to be at most 6 mm, and especially preferred to be at most 4 mm. The lower limit of the difference (Lp−Lo) is preferred to be at least 1 mm.

In the present invention, the width of each of the films 3a and 3b before the welding process is preferred to be at least 600 mm, and more preferred to be at least 1400 mm and at most 2500 mm. However, the present invention is also effective to a film having a width of more than 2500 mm. The thickness of each of the films 3a and 3b before the welding process is preferred to be at least 20 μm and at most 200 μm, and more preferred to be at least 40 μm and at most 100 μm.

In the above embodiment, the heat of the welded overlapped portion 75 is dissipated, but the present invention is not limited to the above embodiment. The overlapped portion 75 may be cooled with a forced air cooling device to cool the heater 55, or a fan that blows cool air onto the overlapped portion 75.

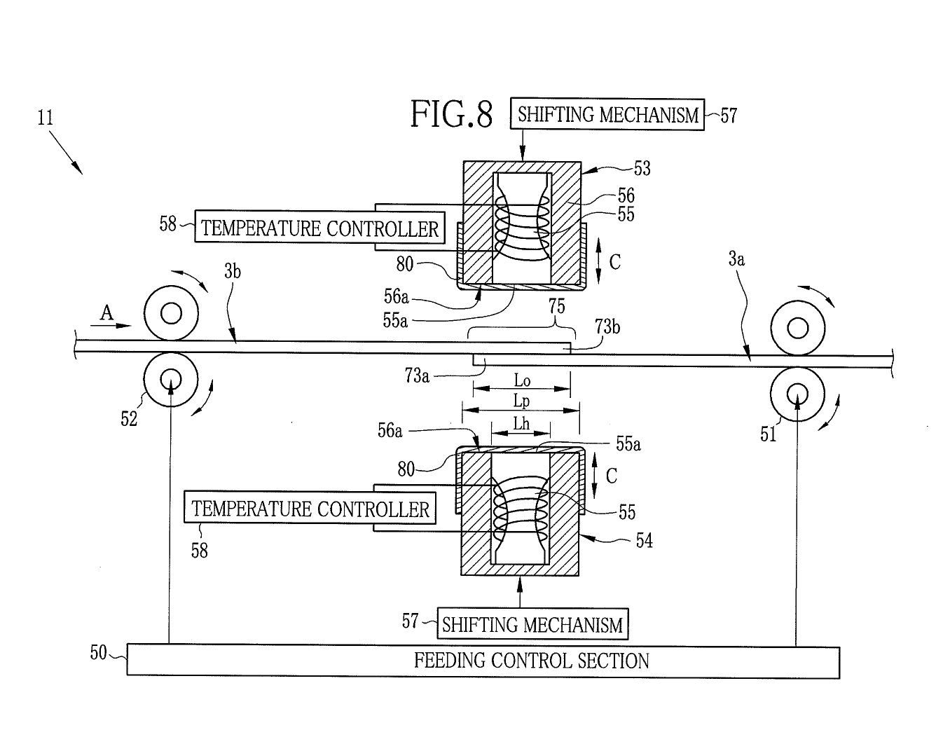

As shown in FIG. 8, the contact surface 56a may be covered with a separating layer 80 formed of glass lining or Teflon (registered trademark) lining. Such separating layer 80 makes the contact surfaces 56a easily separated from the films 3a and 3b, which is preferable. The separating layer 80 may cover the entire or a part of the contact surface 56a, for example, the film heating surface 55a.

Instead of using the welding heads 53 and 54 extending in the film width direction B (see FIG. 4), a pair of welding rollers each incorporating a heater may be used. The overlapped portion 75 may be sandwiched by the pair of the welding rollers, and the pair of the welding rollers is rotated in the film width direction B to perform the welding process to the overlapped portion 75.

To adjust the positions of the rear end 73a and the front end 73b, for example, a line sensor that detects the positions of the rear end 73a and the front end 73b may be used. The nip roller pairs 51 and 52 may control conveyance of the films 3a and 3b based on the position information of the rear end 73a and the front end 73b obtained from the line sensor.

(Solution Casting Method)

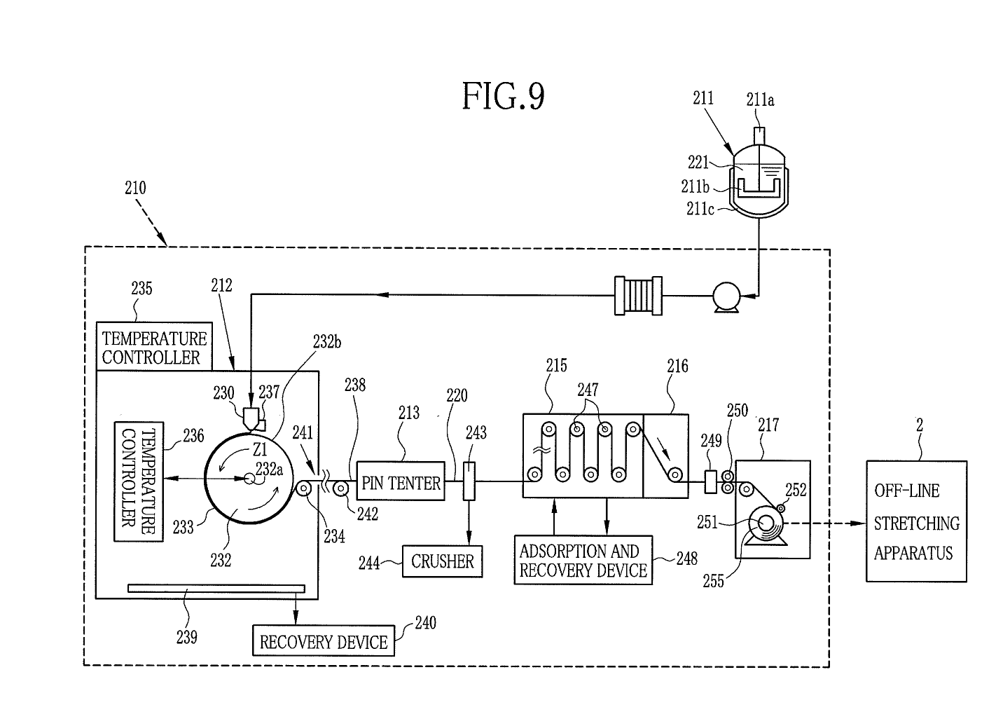

The film described in the above embodiment is produced by a solution casting method. A solution casting apparatus 210 to perform the solution casting method has, as shown in FIG. 9, a stock tank 211, a casting chamber 212, a pin tenter 213, a drying chamber 215, a cooling chamber 216, and a winding chamber 217.

The stock tank 211 is provided with a stirring blade 211b and a jacket 211c. The stirring blade 211b is rotated by a motor 211a. A dope 221 is stored in the stock tank 211. The dope 221 is a mixture or a dispersion liquid of a solvent and polymer that is a raw material of the film 3. The temperature of the dope 221 in the stock tank 211 is kept approximately constant with the use of the jacket 211c. The rotation of the stirring blade 211b prevents coagulation of the polymer and keeps quality of the dope 221 constant. Piping 222 connects the stock tank 211 and a casting die 230.

The casting chamber 212 is provided with the casting die 230, a drum 232 as a support, a peel roller 234, temperature controllers 235 and 236, and a decompression chamber 237. The drum 232 is driven by a driving device (not shown) and rotated around a shaft 232a in a direction Z1. The temperatures inside the casting chamber 212 and the drum 232 are controlled by the temperature controllers 235 and 236 respectively such that the casting film 233 is cooled and solidified (gelated) quickly.

The casting die 230 has a slit extending in a width direction TD. The casting die 230 discharges the dope 221 from the slit to a circumferential surface 232b of the rotating drum 232. After the dope 221 comes in contact with the circumferential surface 232b of the drum 232, the dope 221 is referred to as the casting film 233. The casting film 233 is formed on the circumferential surface 232b of the drum 232. The casting film 233 is gelated and exhibits self-supporting property by approximately 270° (degrees) or three quarters of a rotation. Thereby, the casting film 233 is peeled as a wet film 238 from the drum 232 with the use of the peel roller 234. It is preferred that the residual solvent content in the casting film 233 is in a range from 150 wt. % to 320 wt. %. Here, the residual solvent content in the film 3 is based on a dry basis. The weight percentage of the residual solvent content (dry basis) is an amount obtained by a mathematical expression {(x−y)/y}×100 where x is the weight of a sample film taken from the film 3 to be measured, and y is the weight of the dried sample film.

The decompression chamber 237 is disposed upstream from the casting die 230 with respect to the direction Z1. An inside of the decompression chamber 237 is kept at negative pressure to reduce the pressure of an area on a rear side of a casting bead to a desired value. The casting bead is the dope 221 between the casting die 230 and the circumferential surface 232b. The rear side of the casting bead is the side that is to come in contact with the circumferential surface 232b of the drum 232. By reducing the pressure on the rear side of the casting bead, adverse effects caused by air that is associated with the rotation of the drum 232 is reduced. As a result, the casting bead becomes stable, and the thickness unevenness of the casting film 233 is reduced.

The casting die 230 is formed of a material having a low coefficient of thermal expansion, and high corrosion resistance against electrolytic solution and a liquid mixture of dichloromethane and methanol. It is preferable that the finish precision of a contacting surface of the casting die 230 contacting with the dope is at most 1 μm of the surface roughness, and the straightness is at most 1 μm/m in any direction.

The circumferential surface 232b of the drum 232 is chrome plated and has sufficient corrosion resistance and strength. The temperature controller 236 circulates a heat transfer medium inside the drum 232 to keep the circumferential surface 232b at a desired temperature. The heat transfer medium is kept at a desired temperature. The circumferential surface 232b of the drum 232 is kept at the desired temperature by passing the heat transfer medium through a flow path for the heat transfer medium.

The width of the drum 232 is not particularly limited. The width of the drum 232 is preferred to be in a range from 1.1 times to 2.0 times larger than a casting width of the dope. The material of the drum 232 is preferred to be stainless steel, and more preferred to be SUS316 having sufficient anti-corrosion property and strength. The chrome plating applied to the circumferential surface 232b of the drum 232 is preferred to be so-called hard chrome plating with Vickers hardness (HV) of at least 700 and the plating thickness of at least 2 μm.

The casting chamber 212 is provided with a condenser 239 and a recovery device 240. The condenser 239 condenses and liquefies solvent vapors inside the casting chamber 212. The recovery device 240 recovers the condensed and liquefied solvent. The recovered solvent is refined in the refining device and reused as the solvent for the dope preparation.

A transfer section 241 and the pin tenter 213 are disposed in this order downstream from the casting chamber 212. In the transfer section 241, a roller 242 guides the wet film 238 to the pin tenter 213. The pin tenter 213 has pin plates each provided with a plurality of pins that pierce and hold the side edge of the wet film 238. The pin plates move along a track. Dry air is applied to the wet film 238 conveyed by the pin plates to dry the wet film 238. Thus, a film 220 is formed.

An edge slitting device 243 is provided downstream from the pin tenter 213. The edge slitting device 243 cuts both side edges of the film 220. The cut side edges are blown to a crusher 244 and pulverized, and then reused as a material for the dope or the like.

The drying chamber 215 is provided with a plurality of rollers 247. The film 220 is bridged across the rollers 247 and conveyed. The cooling chamber 216 is provided at an outlet side of the drying chamber 215. In the cooling chamber 216, the film 220 is cooled to room temperature. A compulsory neutralization device (neutralization bar) 249 is provided downstream from the cooling chamber 216 to neutralize the electrical charge on the film 220. A knurling roller pair 250 is provided downstream from the compulsory neutralization device 249 to apply knurling to the both side edges of the film 220. In the winding chamber 217, a winding device 251 having a press roller 252 is disposed. With the use of the winding device 251, the film 220 is wound around a core as a film roll 255. The film roll 255 is sent from the winding chamber 217 to the film supply chamber 4 (see FIG. 1) in the off-line stretching apparatus 2 and used as the film roll 14. The film roll 14 is fed from the film supply chamber 4 as the film 3.

Hereinafter, a raw material polymer of the films 3a and 3b is described. In this embodiment, cellulose acylate is used as a polymer. Especially preferable cellulose acylate is cellulose triacetate (TAC). In the cellulose acylate, it is preferable that the degree of the acyl substitution for hydrogen atoms in hydroxyl groups in cellulose satisfies all of the following formulae (I) to (III):

2.5≦A+B≦3.0 (I)

0≦A≦3.0 (II)

0≦B≦2.9 (III)

In the above formulae (I) to (III), “A” represents a degree of substitution of the hydrogen atom in the hydroxyl group for the acetyl group in cellulose, while “B” represents a degree of substitution of the hydrogen atom in the hydroxyl group for the acyl group with 3 to 22 carbon atoms in cellulose. Preferably, at least 90 wt % of TAC particles has a diameter in the range from 0.1 mm to 4 mm. It should be noted that the polymer to be used in the present invention is not limited to cellulose acylate.

Cellulose has glucose units making β-1,4 bond, and each glucose unit has a free hydroxyl group at second, third, and sixth positions. Cellulose acylate is a polymer in which a part of or the whole of the hydroxyl groups are esterified so that the hydrogen is substituted by the acyl group with two or more carbons. The degree of substitution for the acyl groups in cellulose acylate means a degree of esterification of the hydroxyl group at each of the second, the third, and the sixth positions in cellulose (when the whole (100%) of the hydroxyl group at the same position is substituted, the degree of substitution at this position is 1).

The total degree of substitution for the acyl groups, namely DS2+DS3+DS6, is preferably in the range from 2.00 to 3.00, more preferably in the range from 2.22 to 2.90, and most preferably in the range from 2.40 to 2.88. In addition, DS6/(DS2+DS3+DS6) is preferably at least 0.28, more preferably at least 0.30, and most preferably in the range from 0.31 to 0.34. It should be noted that DS2 is the degree of substitution of the hydrogen atom in the hydroxyl group at second position per glucose unit to the acyl group (hereinafter referred to as a degree of acyl substitution at second position), DS3 is the degree of substitution of the hydrogen atom in the hydroxyl group at third position per glucose unit to the acyl group (hereinafter referred to as a degree of acyl substitution at third position), and DS6 is the degree of substitution of the hydrogen atom in the hydroxyl group at sixth position per glucose unit to the acyl group (hereinafter referred to as a degree of acyl substitution at sixth position).

In the present invention, one or more kinds of the acyl groups may be contained in cellulose acylate. In a case where two or more kinds of acyl groups are in cellulose acylate, it is preferable that one of them is the acetyl group. In a case where a total degree of substitution of the hydroxyl group at the second, the third, and the sixth positions to the acetyl groups and that to acyl groups other than acetyl groups are described as DSA and DSB, respectively, the value of DSA+DSB is preferably in the range from 2.22 to 2.90, and more preferably in the range from 2.40 to 2.88.

In addition, DSB is preferably at least 0.30, and more preferably at least 0.7. In the DSB, the percentage of the substitution of the hydroxyl group at the sixth position is at least 20′, preferably at least 25%, more preferably at least 30%, and most preferably at least 33%. Furthermore, the value of DSA+DSB, in which the hydroxyl group is at the sixth position in cellulose acylate, is preferably at least 0.75, more preferably at least 0.80, and most preferably at least 0.85. By using such cellulose acylate that satisfies the above conditions, a solution (dope) with excellent solubility can be prepared, especially when a non-chlorine organic solvent is used. With the use of the non-chlorine organic solvent, the solution has low viscosity and excellent filterability. Cellulose as a material of cellulose acylate may be obtained from either linter or pulp.

According to the present invention, as for cellulose acylate, the acyl group having at least 2 carbon atoms may be either aliphatic group or aryl group, and is not especially limited. Examples of the cellulose acylate include alkylcarbonyl ester, alkenylcarbonyl ester, aromatic carbonyl ester, aromatic alkylcarbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group, and the like. Of those, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

Details of cellulose acylate are described in paragraphs [0140] to [0195] in Japanese Patent Laid-Open Publication No. 2005-104148. Such description is also applicable to the present invention. In addition, the solvent and the additives (such as a plasticizer, a deterioration inhibitor, a UV-absorbing agent, an optical anisotropy controller, a retardation controller, dye, a matting agent, a release agent, a release improver, and the like) are also detailed in paragraphs [0196] to [0516] in the same publication.

(Solvent)

Examples of solvents to be used for preparing the dope include aromatic hydrocarbon (for example, benzene, toluene, and the like), halogenated hydrocarbon (for example, dichloromethane, chlorobenzene, and the like), alcohol (for example, methanol, ethanol, n-propanol, n-butanol, diethyleneglycol, and the like), ketone (for example, acetone, methyl ethyl ketone, and the like), ester (for example, methylacetate, ethylacetate, propylacetate, and the like), ether (for example, tetrahydrofuran, methyl cellosolve, and the like), and the like. It should be noted that in the present invention the dope means a polymer solution or dispersion solution that is obtained by dissolving or dispersing the polymer in the solvent.

The halogenated hydrocarbon preferably has 1 to 7 carbon atoms, and dichloromethane is most preferable. In view of physical properties of the TAC, such as solubility, peelability of a casting film from the support, a mechanical strength of the film, and optical properties of the film, it is preferable to use at least one kind of alcohol having 1 to 5 carbon atoms together with dichloromethane. The content of alcohol is preferably in the range from 2 wt % to 25 wt %, and more preferably in the range from 5 wt % to 20 wt % relative to the whole solvent. Examples of alcohols include, for example, methanol, ethanol, n-propanol, iso-propanol, n-butanol, and the like, and especially methanol, ethanol, n-butanol, and a mixture of them are preferably used.

Recently, in order to reduce adverse influence on the environment to the minimum, the use of a solvent containing no dichloromethane is examined. In this case, the solvent preferably contains ether with 4 to 12 carbon atoms, ketone with 3 to 12 carbon atoms, ester with 3 to 12 carbon atoms, alcohol with 1 to 12 carbon atoms, or a mixture of them. For example, a solvent mixture may contain methylacetate, acetone, ethanol, and n-butanol. It should be noted that ether, ketone, ester, and alcohol may have a cyclic structure. A compound having at least two functional groups thereof (that is, —O—, —CO—, —COO—, and —OH) may be used as the solvent.

In the above embodiment, TAC is used as the raw material polymer for producing the films 3a and 3b. The raw material polymer is not limited to the above. Cyclic olefins, other cellulose ester, for example, cellulose acetate propionate or the like may be used. The present invention is also applicable to polymer films produced by melt extrusion methods.

(Melt Extrusion Method)

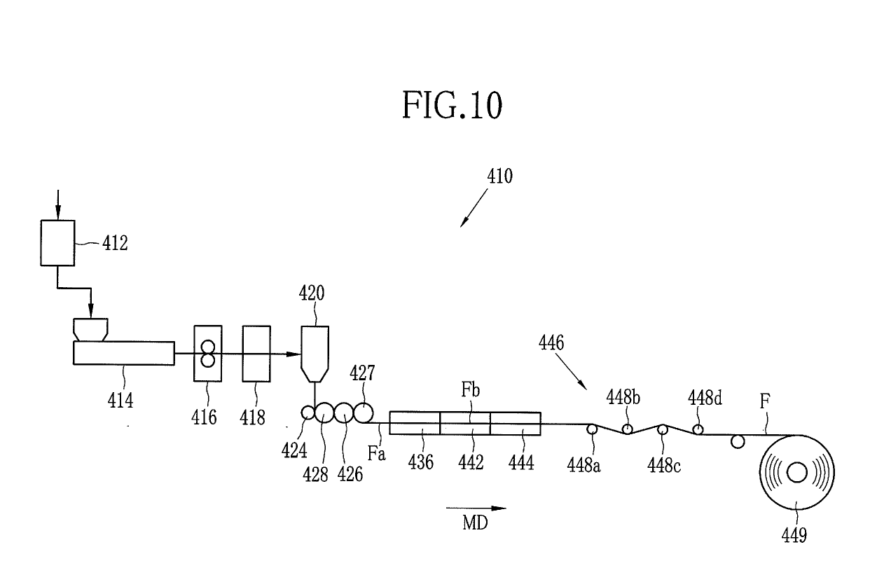

Next, a production apparatus (hereinafter referred to as melt extrusion apparatus) for producing polymer films by a melt extrusion method is described. As shown in FIG. 10, a melt extrusion apparatus 410 is used for producing a thermoplastic film F for use in an LCD device or the like. Pelletized thermoplastic polymer as the raw material for the thermoplastic film F is put in a dryer 412 and dried. Then, the pellets are extruded by an extruder 414 and fed to a filter 418 through a gear pump 416. Foreign substances are filtered through the filter 418. Melted polymer (melted thermoplastic polymer) is extruded from a die 420. The melted polymer is sandwiched between and pressed by a first casting roll 428 and a touch roll 424. Then, the melted polymer is cooled and solidified on the first casting roll 428 to be a film having predetermined surface roughness. Thereafter, the film is conveyed by a second casting roll 426 and a third casting roll 427. Thereby, a non-stretched film Fa is produced. The non-stretched film Fa may be wound at this point. Alternatively, the non-stretched film Fa may be supplied successively to a width-stretching section 442 in which a long-span stretching is performed continuously. It is also possible to supply the wound non-stretched film Fa to the width-stretching section 442. There is no difference in effect between using the wound non-stretched film Fa and the continuously fed non-stretched film Fa.

In the width-stretching section 442, the non-stretched film Fa is stretched in a width direction (hereinafter referred to as TD direction) orthogonal to a conveying direction (hereinafter referred to as MD direction), and thereby referred to as a width-stretched film Fb. A preheating section 436 may be provided upstream from the width-stretching section 442. A thermosetting section 444 may be provided downstream from the width-stretching section 442. Thereby, bowing (deviation of an optical axis) is reduced during the stretching. It is preferred that the preheating temperature is higher than the width-stretching temperature, and the thermosetting temperature is lower than the width-stretching temperature. Generally, a center portion of the film in the width direction grows concave with respect to the conveying direction due to bowing. Such bowing is reduced by setting the preheating temperature higher than the width-stretching temperature (the preheating temperature>the width-stretching temperature) and the width-stretching temperature higher than the thermosetting temperature (width-stretching temperature>thermosetting temperature). At least one of the preheating process and the thermosetting process may be performed.

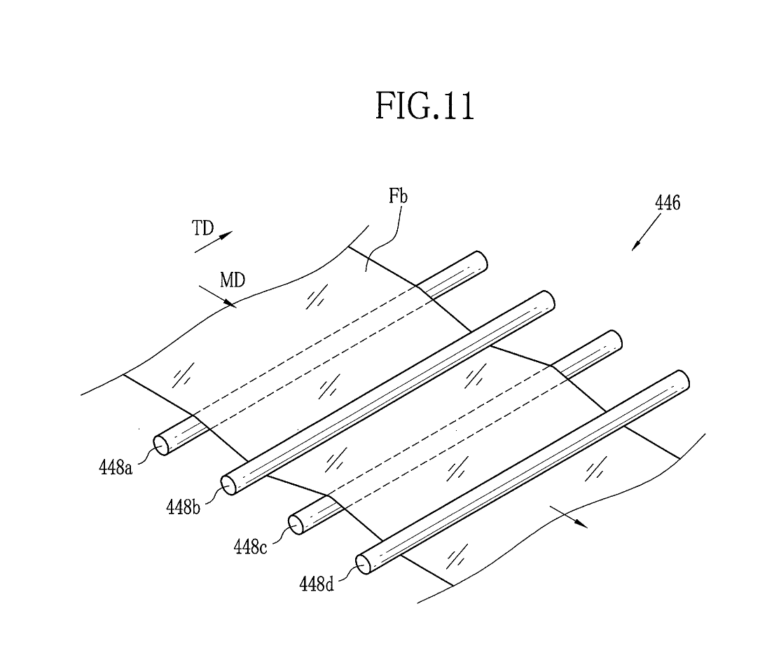

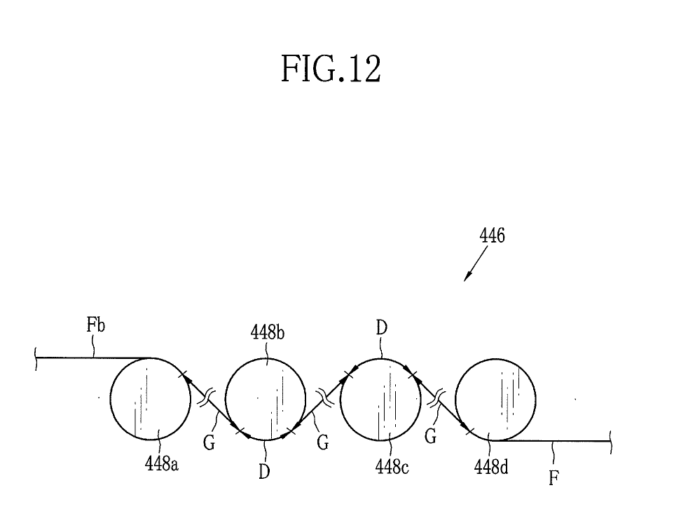

In a case where the thermosetting process is performed after the width-stretching, the width-stretched film Fb is contracted in the MD direction in the heat treatment zone 446. In the heat treatment zone 446, as shown in FIG. 11, the width-stretched film Fb is conveyed by rollers 448a to 448d in a state that the side edges of the width-stretched film Fb are not held by chucks so as to be contracted only in the MD direction while contraction thereof in the TD direction is prevented. As shown in FIG. 12, rollers 448a to 448d are arranged such that a ratio (G/D) between a roller interval length (G) and a lap length (D) is to be at least 0.01 and at most 3. The roller interval length (G) is a length of the width-stretched film Fb between the rollers 448a and 448b, 448b and 448c, or 448c and 448d. The lap length (D) is a length of the width-stretched film Fb contacting with the roller 448b or 448c. Thereby, friction between the width-stretched film Fb and each of the rollers 448a to 448d prevents the contraction of the width-stretched film Fb in the TD direction. The width-stretched film Fb is subjected to the heat treatment while being conveyed. During the conveyance, a ratio (V2/V1) between a peripheral speed (V2) of the downstream roller 448d and a peripheral speed (V1) of the upstream roller 448a is kept to at least 0.6 and at most 0.999. Namely, the width-stretched film Fb is contracted in the MD direction in the heat treatment zone 446.

The width-stretched film Fb is subjected to the heat treatment in the heat treatment zone 446, and thus a thermoplastic film F is produced. The thermoplastic film F is a final product in which an orientation angle and retardation are adjusted as necessary. The thermoplastic film F is wound by a winding section 449.

The non-stretched film Fa may be stretched in the MD direction before being stretched in the TD direction. Additionally, the width-stretched film Fb may be stretched in the TD direction after the stretching in the TD direction. The film is stretched in the MD direction with the use of plural nip roller pairs aligned in the MD direction to convey the film. During the conveyance, a peripheral speed of the upstream nip roller pair is made faster than that of the downstream nip roller pair. The film stretching method depends on a ratio (L/W) between a distance or a length (L) between nip roller pairs in the MD direction and a film width (W) sandwiched by the nip roll pair on the upstream side. In a case where the ratio L/W is small, the stretching method in the MD direction as disclosed in Japanese Patent Laid-Open Publications No. 2005-330411 or No. 2006-348114 may be used. Such methods make the apparatus compact although Rth values tend to increase. On the other hand, in a case where the ratio L/W is large, the stretching method as disclosed in Japanese Patent Laid-Open Publication No. 2005-301225 may be used. Such methods reduce the Rth values although the apparatus tends to be upsized.

A polymer for use in the melt extrusion method is not particularly limited as long as it is a thermoplastic polymer, for example, cellulose acylate, polymer containing lactone ring, cyclic olefin, polycarbonate, or the like. Of those, cellulose acylate and cyclic olefin are preferred. Of those, cellulose acylate containing an acetate group or a propionate group, cyclic olefin synthesized by addition polymerization are preferred. The cyclic olefin synthesized by addition polymerization is more preferred.

(Cyclic Olefin)

Cyclic olefin synthesized by polymerization of norbornene-based compound is preferred. This polymerization is either ring opening polymerization or addition polymerization. Examples of addition polymerization are disclosed in, for example, Japanese Patents No. 3517471, No. 3559360, No. 3867178, No. 3871721, No. 3907908, and No. 3945598, PCT International Publication No. WO2004/007587 (corresponding to Japanese translation of PCT International Publication No. 2005-527696), Japanese Patent Laid-Open Publication No. 2006-028993, and PCT International Publication No. WO2006/004376. Of those, the addition polymerization disclosed in Japanese Patent No. 3517471 is especially preferred.

Examples of ring opening polymerization are disclosed in, for example, PCT International Publication No. WO1998/014499, and Japanese Patents No. 3060532, No. 3220478, No. 3273046, No. 3404027, No. 3428176, No. 3687231, No. 3873934, and No. 3912159. Of those, ring opening polymerization disclosed in PCT International Publication No. WO1998/014499 and Japanese Patent No. 3060532 are preferable.

Of those, the cyclic olefin synthesized by addition polymerization is more preferred.

(Polymer Containing Lactone Ring)

Polymer containing lactone ring has lactone ring structure represented by general formula 1 below.

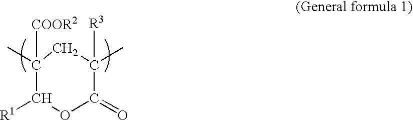

In the general formula 1, each of R¹, R², and R³ represents a hydrogen atom or organic residue containing one to 20 carbon atoms. The organic residue may contain an oxygen atom.

A content of the lactone ring structure represented by the general formula 1 is preferably in a range from 5 wt. % to 90 wt. %, more preferably in a range from 10 wt. % to 70 wt. %, and further more preferably in a range from 10 wt. % to 50 wt. %.

Other than the lactone structure represented by the general formula 1, a polymer structural unit (or structural repeating unit) composed of at least one of (meth)acrylic ester, monomer containing a hydroxyl group, unsaturated carbonic acid, and a monomer represented by general formula 2 below.

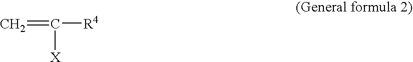

In the above general formula 2, R⁴ represents a hydrogen atom or a methyl group. X represents a hydrogen atom, an alkyl group having one to 20 carbon atoms, an aryl group, —OAc group, —CN group, —CO—R⁵ group, or —C—O—R⁶ group. The Ac group represents an acetyl group. Each of R⁵ and R⁶ represents a hydrogen atom or organic residue having one to 20 carbon atoms.

Examples of the polymer containing lactone ring are disclosed in PCT International Publication No. WO2006/025445, Japanese Patent Laid-Open Publications No. 2007-070607, No. 2007-063541, No. 2006-171464, and No. 2005-162835.

The present invention is not to be limited to the above embodiments, and on the contrary, various modifications will be possible without departing from the scope and spirit of the present invention as specified in claims appended hereto.

What is claimed is:

1. A method for continuously stretching polymer films comprising the steps of:
(a) overlapping a rear end of a preceding polymer film and a front end of a trailing polymer film as an overlapped portion;
(b) splicing said overlapped portion by holding and welding said overlapped portion between a pair of welding heads in an overlapping direction, each said welding head having a film contact surface to contact with said overlapped portion and a film heating surface to heat said overlapped portion, a length Lo of said overlapped portion in a conveying direction of said polymer films, a length Lp of said film contact surface in said conveying direction, a length Lh of said film heating surface in said conveying direction satisfying Lh<Lo<Lp, center portions of said overlapped portion, said film contact surface, and said film heating surface being approximately aligned with each other in said conveying direction, ends of said overlapped portion in said conveying direction being heated during said welding to a temperature at which said polymer films are welded to each other; and
(d) stretching said spliced polymer film in a width direction in a state that side edges of said spliced polymer film in said width direction are held.

2. The method of claim 1, wherein each of said welding heads is provided with a separating layer, and said separating layer covers said film contact surface and said film heating surface, and said overlapped portion is welded through said separating layers.

3. The method of claim 1, wherein said length Lo is at least 5 mm and at most 10 mm, and a difference (Lp−Lo) is at most 10 mm.

4. An apparatus for continuously stretching polymer films in a film width direction comprising:
a pair of welding heads for holding, welding, and splicing an overlapped portion of said polymer films in an overlapping direction, each said welding head having a film contact surface to contact with said overlapped portion and a film heating surface to heat said overlapped portion, a length Lp of said film contact surface in a conveying direction of said polymer films and a length Lh of said film heating surface in said conveying direction satisfying Lh<Lp, said film heating surface being approximately flush with said film contact surface and extending from a center portion toward ends of said film contact surface in said conveying direction at approximately equal lengths, center portions of said film contact surface and said film heating surface being approximately aligned to each other in said conveying direction;
a film conveying device for overlapping a rear end of a preceding polymer film and a front end of a trailing polymer film as said overlapped portion in such a manner that center portions of said overlapped portion and said film heating surface are approximately aligned with each other in said conveying direction and a length Lo of said overlapped portion in said conveying direction satisfies Lh<Lo<Lp;
a heating control device for controlling a temperature of said film heating surface such that ends of said overlapped portion in said conveying direction are heated during said welding to a temperature at which said polymer films are welded to each other.

5. The apparatus of claim 4, wherein each of said welding heads is provided with a separating layer, and said separating layer covers said film contact surface and said film heating surface.
